(19) United States
(12) Patent Application Publication
(10) Pub. No.: US 2009/0067781 A1
(43) Pub. Date: Mar. 12, 2009

(54) OPTICAL SWITCH

(75) Inventors: Yao-Joe Yang, Taipei (TW); Kuang-Chao Fan, Taipei (TW); Tien-Tung Chung, Taipei (TW); Bo-Ting Liao, Yunlin County (TW)

Correspondence Address: HOFFMANN & BARON, LLP, 6900 JERICHO TURNPIKE, SYOSSET, NY, 11791, US

(73) Assignee: NATIONAL TAIWAN UNIVERSITY, Taipei (TW)

(21) Appl. No.: 11/853,352

(22) Filed: Sep. 11, 2007

(51) Int. Cl. G02B 6/26

(52) U.S. Cl. 385/18

(57) ABSTRACT

The present invention discloses an optical switch having an optical switching function as well as an add/drop function. The optical switch includes two add optical fibers and two drop optical fibers. In addition to the optical switching function of the optical switch achieved by four movable mirrors, the optical switch also has the add/drop function when the four movable mirrors are moved out of the optical path. Therefore, the optical switch of the invention concurrently provides the optical switching function as well as the add/drop functions.

### FIELD OF THE INVENTION

The present invention relates to an optical switch, and more particularly to an optical switch having an add/drop function in addition to an optical switching function.

### BACKGROUND OF THE INVENTION

As optical fiber networks increasingly develop, optical switches tend to be developed in the trend of all-optical network. If optical signals can be switched in an optical domain without optical-electrical-optical conversions, the processing speed will be increased, and the excess loss caused by the optical-electrical-optical conversion can be eliminated. Thus, the optical switch for switching signals in an optical domain will definitely play an important role in developing optical communication components.

In recent years, precision mechanical technology and micro electro-mechanical system (MEMS) technology are developed rapidly. Due to the advantage of high precision, these technologies are quite suitable to be utilized in developing optical switches. For example, a MEMS optical switch and its manufacturing method (as disclosed in R.O.C. Pat. No. 475999), an optical switch and an optical switch array (as disclosed in R.O.C. Pat. No. 581897), and a micro-machined optical switch with tapered ends (as disclosed in U.S. Pat. No. 6,108,466) control the position of a mirror by an actuator, so that the mirror can be moved into or out of an optical path to achieve switching optical signals. Referring to FIG. 1(a)-(b) for a schematic view of an operation of a prior art optical switch, the prior art 2×2 cross-bar optical switch 10a, as shown in FIG. 1(a), has input optical fibers 12a, 13a and output optical fibers 11a, 14a arranged in a cross-shape, and the position of a movable mirror 21a is controlled by a linear actuator. If the movable mirror 21a is moved out of the optical paths of the output optical fibers 11a, 14a and the input optical fibers 12a, 13a, the optical signals 31a, 32a will be transmitted from the input optical fibers 13a, 12a to the output optical fibers 11a, 14a respectively. If the movable minor 21a is moved into the optical paths of the output optical fibers 11a, 14a and the input optical fibers 12a, 13a, the optical signals 31a, 32a will be reflected to the output optical fibers 14a, 11a through the movable mirror 21a respectively. However, the reflected optical signals 31a, 32a are affected by the thickness of the mirror and thus will not be aligned with the optical axes 31a′, 32a′. There will be an “optical misalignment” as shown in FIG. 1(b), and the optical misalignment will increase optical loss significantly.

To overcome the aforementioned problem of the optical misalignment is to use a very thin mirror such as a mirror of 1˜2 μm thick, but the difficulty of fabricating such a thin double-sided mirror will be increased greatly. Also, the process yield will consequently decrease. Another conventional design of optical switches uses mirror arrays. Single-sided mirrors, rather than double-sided mirrors, are used in the mirror arrays to reflect optical signals. Thus, the optical misalignment problem due to the mirror thickness can be avoided. Optical switches utilizing mirror arrays include a cross-connect optical switch (as disclosed in U.S. Pat. No. 6,862,381), a micromachined optical switching device (as disclosed in U.S. Pat. No. 6,445,840), and an optical switch (as disclosed in R.O.C. Pat. No. 589468). Referring to FIG. 2(a)-(b) for a prior art optical switch, a 2×2 optical switch is used as an example for the illustration. A prior art 2×2 mirror-array optical switch 10b, as shown in FIG. 2(a), includes input optical fibers 12b, 13b and output optical fibers 11b, 14b arranged perpendicular to each other, and movable mirrors 21b, 22b, 23b, 24b controlled by linear actuators. If the movable mirrors 21b, 24b are moved into the optical paths, the optical signals 31b, 32b will be reflected by the movable mirrors 21b, 24b and be redirected to the output optical fibers 14b, 11b respectively. Similarly, if the movable mirrors 22b, 23b are moved into the optical paths, the optical signals 31b, 32b will be reflected by the movable mirrors 23b, 22b and be transmitted to the output optical fibers 11b, 14b respectively as shown in FIG. 2(b). However, single-sided movable mirrors 21b, 22b, 23b, 24b are used for reflecting optical signals, and thus more movable mirrors and linear actuators are required. For instance, the mirror-array optical switch 10b requires four linear actuators to control four movable mirrors respectively. Thus, the complexity of the systems will be increased, and the fabrication yield will also be lowered.

There is a solution for reducing the quantity of components as disclosed in R.O.C. Pat. No. M298130. Referring to FIG. 3(a)-(b) for a schematic, view of an operation of a prior art optical switch, the prior art 2×2 optical switch 10c includes input optical fibers 12c, 13c, output optical fibers 11c, 14c, fixed mirrors 23c, 24c and movable mirrors 21c, 22c. The fixed mirror 23c is parallel to the fixed mirror 24c, and the movable mirror 21c is parallel to the movable mirror 22c. The positions of the movable mirrors 21c, 22c are controlled by linear actuators, so that the movable mirrors 21c, 22c can be moved into or out of the optical paths. If the movable mirrors 21c, 22c are moved out of the optical paths, the optical signals 31c, 32c are reflected by the fixed mirrors 23c, 24c and be redirected to the output optical fibers 14c, 11c respectively as shown in FIG. 3(a). If the movable mirrors 21c, 22c are moved into the optical paths, the optical signals 31c, 32c will be reflected by the movable mirrors 21c, 22c and be transmitted to the output optical fibers 11c, 14c respectively as shown in FIG. 3(b). Since the output optical fibers 11c, 14c and the input optical fibers 12c, 13c are rearranged, only two movable mirrors 21c, 22c and two linear actuators are required. However, the prior art optical switch 10c provides an optical switching function only.

Therefore, inventing an optical switch with an optical switching function as well as an add/drop function is the main subject of the present invention.

### SUMMARY OF THE INVENTION

In view of the foregoing shortcomings of the prior art optical switch, the inventor of the present invention based on years of experience in the related field to conduct extensive researches and experiments, and finally developed an optical switch, in hope of achieving an optical switch with an optical switching function as well as an add/drop function.

Therefore, it is a primary objective of the present invention to provide an optical switch comprising two add optical fibers and two drop optical fibers, such that optical signals can be added to the two output optical fibers or can be dropped from the two input optical fibers. The optical switch with an optical switching function as well as an add/drop function can be achieved.

To achieve the foregoing objective, an optical switch comprises: a first input optical fiber, for generating a first optical signal to be reflected to a first output optical fiber through a first movable mirror; a second movable mirror, installed between the first input optical fiber and the first movable mirror; a second input optical fiber, for generating a second optical signal to be reflected to a second output optical fiber through a third movable mirror; a fourth movable mirror; installed between the second input optical fiber and the third movable mirror; wherein if the second movable mirror and the fourth movable mirror are moved into the optical paths of the first optical signal and the second optical signal respectively, the first optical signal will be reflected to the second output optical fiber through the second movable mirror, and the second optical signal will be reflected to the first output optical fiber through the fourth movable mirror; and if the four movable mirrors are moved out of the optical paths of the first optical signal and the second optical signal, the first optical signal will be dropped to the first drop optical fiber, and the second optical signal will be dropped to the second drop optical fiber, and the first add optical fiber will generate a third optical signal to be added to the first output optical fiber, and a the second add optical fiber will generate a fourth optical signal to be added to the second output optical fiber. Therefore, the optical switch can provide the optical switching function as well as the add/drop functions.

The above and other objects, features and advantages of the present invention will become apparent from the following detailed description taken with the accompanying drawing.

### BRIEF DESCRIPTION OF THE DRAWINGS

FIG. 1(a)-(b) is a schematic view of an operation of a prior art optical switch;

FIG. 2(a)-(b) is a schematic view of an operation of a prior art optical switch;

FIG. 3(a)-(b) is a schematic view of an operation of a prior art optical switch; and

FIG. 4(a)-(c) is a schematic view of an operation in accordance with a preferred embodiment of the present invention.

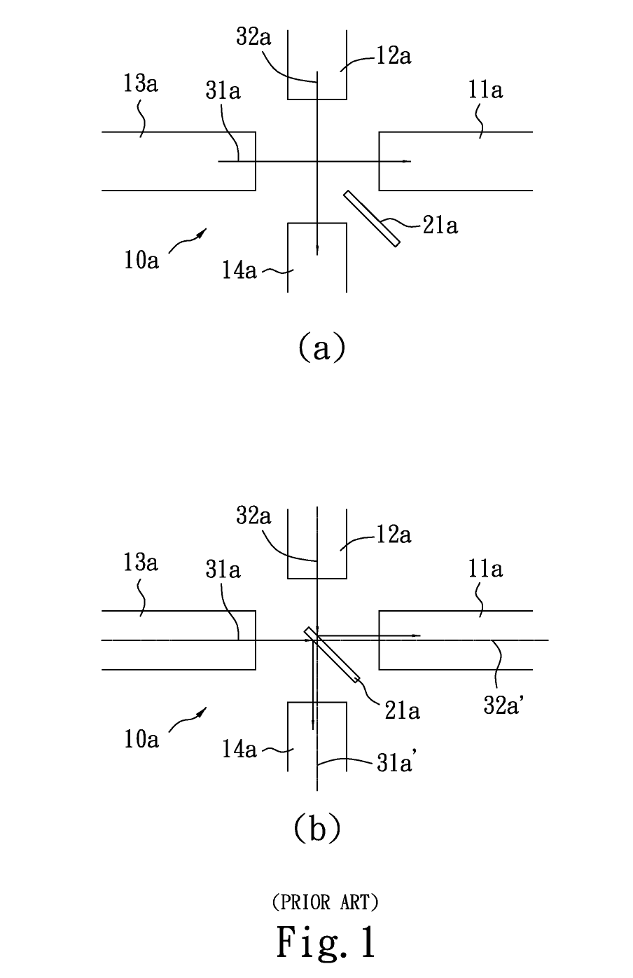

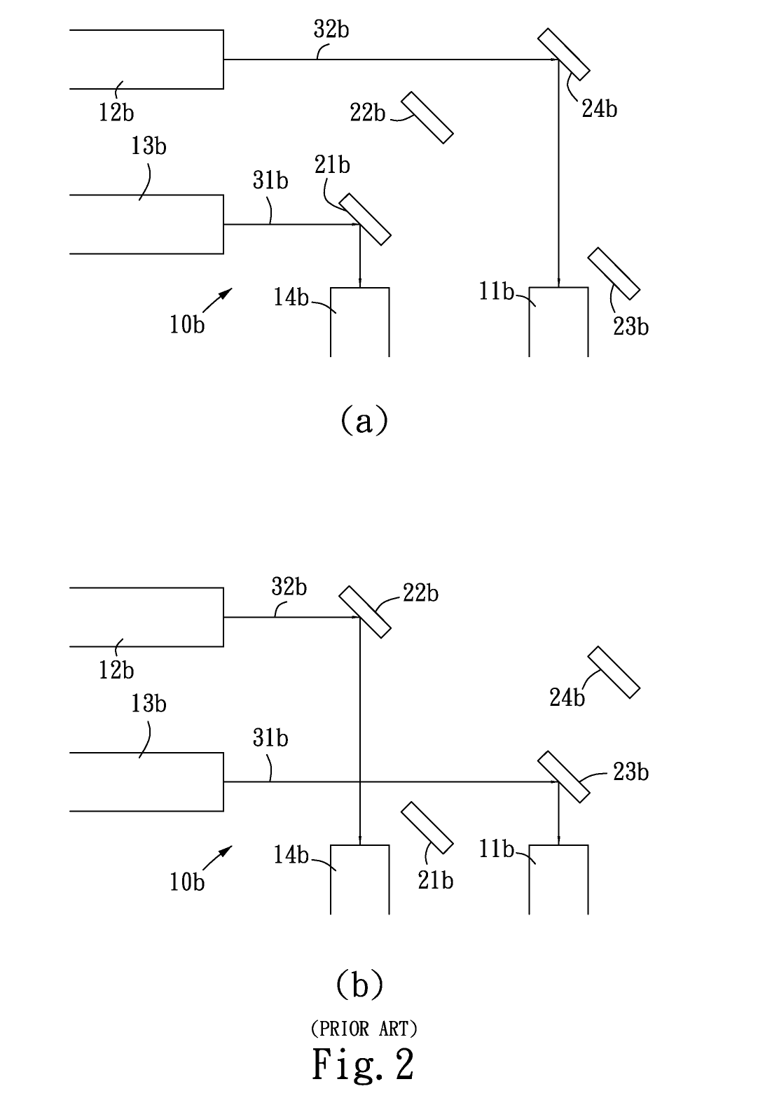

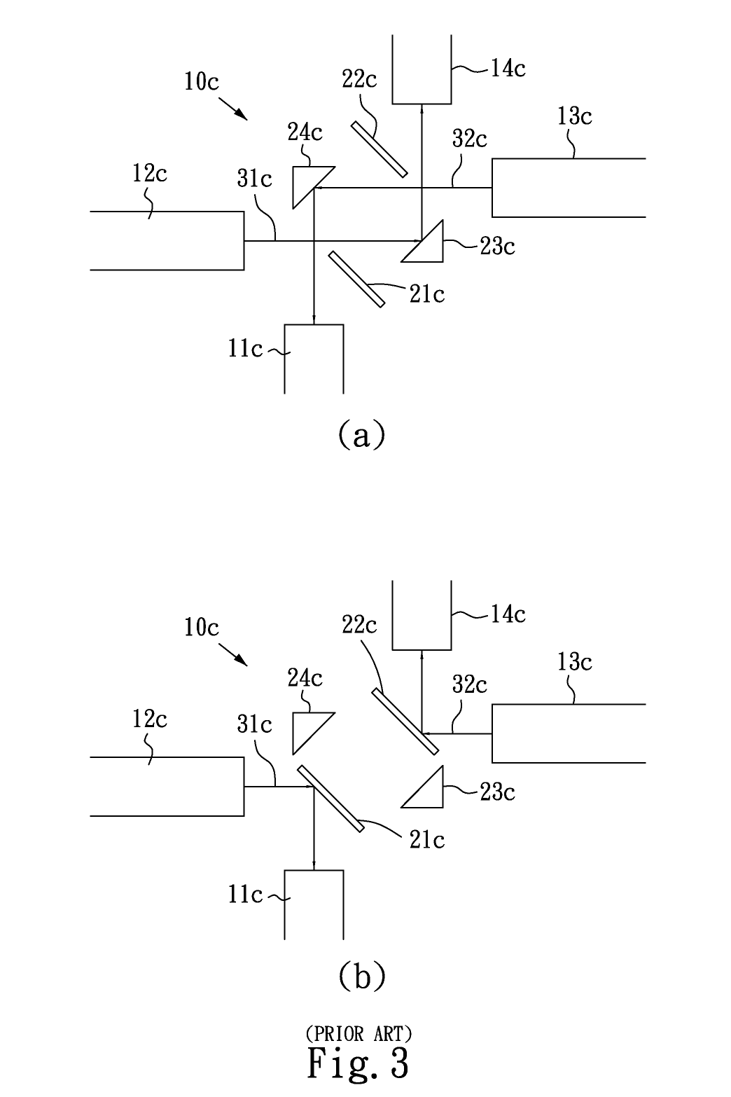

### DETAILED DESCRIPTION OF THE PREFERRED EMBODIMENTS

To make it easier for our examiner to understand the objective, innovative features and performance of the present invention, we use a preferred embodiment and the accompanying drawings for a detailed description of the present invention.

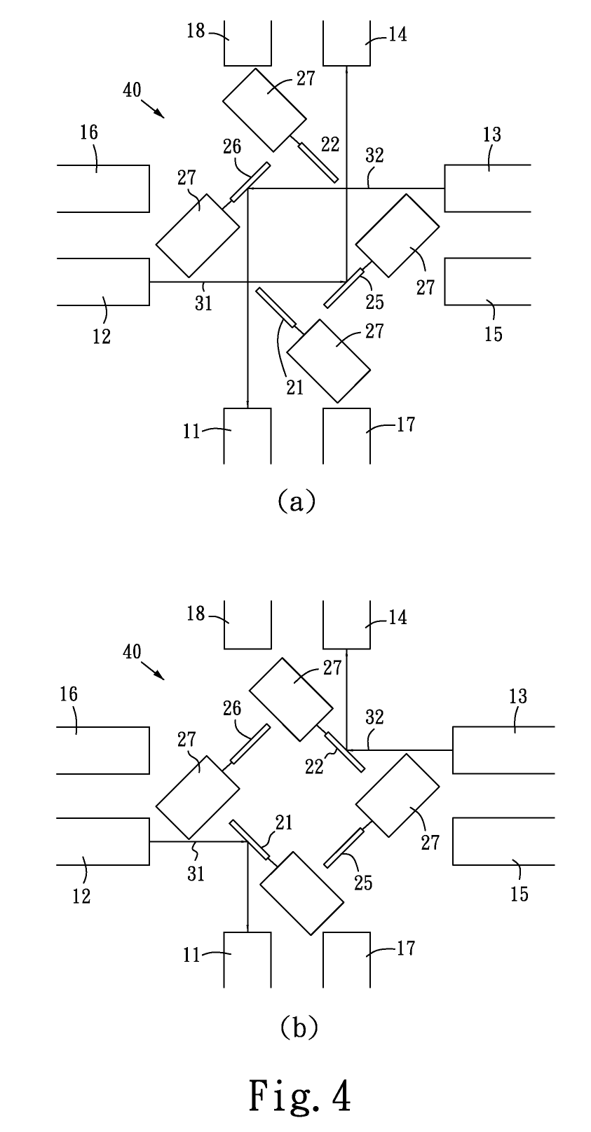

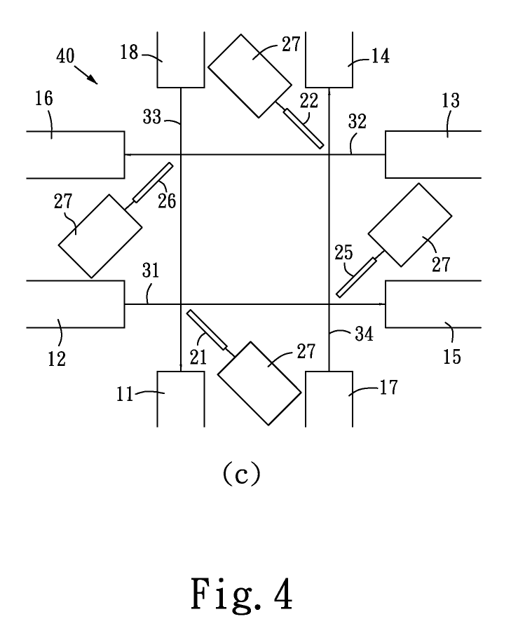

Referring to FIG. 4(a)-(c) for a schematic view of an operation in accordance with a preferred embodiment of the present invention, an optical switch 40 comprises a first input optical fiber 13, a second input optical fiber 12, a first output optical fiber 11, a second output optical fiber 14, a first add optical fiber 18, a second add optical fiber 17, a first drop optical fiber 16, a second drop optical fiber 15, a first movable mirror 26, a second movable mirror 22, a third movable mirror 25 and a fourth movable mirror 21.

Four movable mirrors 21, 22, 25, 26 are driven by linear actuators (not shown in the figure) and they are single-sided mirrors. The first optical signal 32 generated by the first input optical fiber 13 is reflected by the first movable mirror 26 and is redirected to the first output optical fiber 11. The second optical signal 31 generated by the second input optical fiber 12 is reflected by the third movable mirror 25 and is transmitted to the second output optical fiber 14. The second movable mirror 22 is installed between the first input optical fiber 13 and the first movable mirror 26, and the fourth movable mirror 21 is installed between the second input optical fiber 12 and the third movable mirror 25, and the first movable mirror 26 is parallel to the third movable mirror 25, and the second movable mirror 22 is parallel to the fourth movable mirror 21. If the second movable mirror 22 and the fourth movable mirror 21 are moved into the optical paths, the first optical signal 32 is reflected to the second output optical fiber 14 through the second movable mirror 22, and the second optical signal 31 is reflected to the first output optical fiber 11 through the fourth movable mirror 21. The above-mentioned features complete the optical switching function.

If the four movable mirrors 21, 22, 25, 26 are moved out of the optical paths, the first optical signal 32 is dropped to the first drop optical fiber 16, and the second optical signal 31 is dropped to the second drop optical fiber 15. The first add optical fiber 18 generates a third optical signal 33 to be added to the first output optical fiber 11, and the second add optical fiber 17 generates a fourth optical signal 34 to be added to the second output optical fiber 14. The above-mentioned features complete the add/drop functions.

Besides, the four movable mirrors 21, 22, 25, 26 are moved out of the optical paths of the first optical signal 32, the second optical signal 31, the third optical signal 33 and the fourth optical signal 34. The optical path of the first optical signal 32 is parallel to that of the second optical signal 31. The optical path of the third optical signal 33 is parallel to that of the fourth optical signal 34. The transmission direction of the first optical signal 32 is opposite to that of the second optical signal 31, and the transmission direction of the third optical signal 33 is opposite to that of the fourth optical signal 34. The transmission path of the first optical signal 32 is perpendicular to that of the third optical signal 33, and the transmission path of the second optical signal 31 is perpendicular to that of the fourth optical signal 34.

In addition to the optical switching function, the optical switch 40 of the invention also provides the add/drop function. Thus, the optical switch 40 of the invention is also called “Optical Add-Drop Module”.

In summation of the description above, the present invention installs two add optical fibers and two drop optical fibers. Two optical signals can be dropped from two input optical fibers to the drop optical fibers. Also, two optical signals that are generated from two add optical fibers can be added to the output optical fibers. The invention can achieve the optical switching function as well as the add/drop function. The present invention herein enhances the performance than the conventional structure and further complies with the patent application requirements, and thus is duly filed for a patent application.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical switch, comprising:
a first input optical fiber, for transmitting a first optical signal generated by the first input optical fiber to a first output optical fiber through a first movable mirror;
a second movable mirror, installed between the first input optical fiber and the first movable mirror;
a second input optical fiber, for transmitting second optical signal generated by the second input optical fiber to a second output optical fiber through a third movable mirror; and
a fourth movable mirror, installed between the second input optical fiber and the third movable mirror;
thereby, if the second movable mirror and the fourth movable mirror are moved into the optical paths of the first optical signal and the second optical signal respectively, the first optical signal is reflected to the second output optical fiber through the second movable mirror, and the second optical signal is reflected to the first output optical fiber through the fourth movable mirror; and if the four movable mirrors are moved out of the optical paths of the first optical signal and the second optical signal respectively, the first optical signal is dropped to a first drop optical fiber, and the second optical signal is dropped to a second drop optical fiber.

2. The optical switch as recited in claim 1, wherein if the four movable mirrors are moved out of the optical paths of the first optical signal and the second optical signal, a first add optical fiber generates a third optical signal to be added to the first output optical fiber, and a second add optical fiber generates a fourth optical signal to be added to the second output optical fiber.

3. The optical switch as recited in claim 1, wherein if the four movable mirrors are moved out of the optical paths of the first optical signal and the second optical signal, the optical path of the first optical signal is parallel to the optical path of the second optical signal, and the transmission direction of the first optical signal is opposite to the transmission direction of the second optical signal.

4. The optical switch as recited in claim 1, wherein if the four movable mirrors are moved out of the optical paths of the third optical signal and the fourth optical signal, the optical path of the third optical signal is parallel to the optical path of the fourth optical signal, and the transmission direction of the third optical signal is opposite to the transmission direction of the fourth optical signal.

5. The optical switch as recited in claim 1, wherein if the four movable mirrors are moved out of the optical paths of the four optical signals, the optical path of the first optical signal is perpendicular to the optical path of the third optical signal, and the optical path of the second optical signal is perpendicular to the optical path of the fourth optical signal.

6. The optical switch as recited in claim 1, wherein the first movable mirror is parallel to the third movable mirror.

7. The optical switch as recited in claim 1, wherein the second movable mirror is parallel to the fourth movable mirror.

8. The optical switch as recited in claim 1, wherein the first optical signal is reflected perpendicularly to the first output optical fiber through the first movable mirror, and the second optical signal is reflected perpendicularly to the second output optical fiber through the third movable mirror.

9. The optical switch as recited in claim 1, wherein if the second movable mirror and the fourth movable mirror are moved into the optical paths of the first optical signal and the optical path of the second optical signal respectively, the first optical signal is reflected perpendicularly to the second output optical fiber through the second movable mirror, and the second optical signal is reflected perpendicularly to the first output optical fiber through the fourth movable mirror.

10. The optical switch as recited in claim 1, wherein the four movable mirrors are driven to be moved by a linear actuator.

11. The optical switch as recited in claim 1, wherein the four movable mirrors are single-sided mirrors.
